(19) United States
(12) Patent Application Publication
(10) Pub. No.: US 2006/0260996 A1
(43) Pub. Date: Nov. 23, 2006

(54) METHOD AND APPARATUS FOR COMBINED FILTRATION AND ANTI-MICROBIAL TREATMENT OF STORM WATER RESIDENT IN STORM WATER SYSTEMS

(76) Inventors: Kathy Brownstein, Issaquah, WA (US); Jerry Brownstein, Issaquah, WA (US); Brent Hepner, Maple valley, WA (US)

Correspondence Address: LAW OFFICES OF RONALD M ANDERSON, 600 108TH AVE, NE, SUITE 507, BELLEVUE, WA, 98004, US

(21) Appl. No.: 11/457,665

(22) Filed: Jul. 14, 2006

Related U.S. Application Data
(63) Continuation-in-part of application No. 10/646,944, filed on Aug. 21, 2003.
Application No. 10/646,944 is a division of application No. 09/875,591, filed on Jun. 6, 2001, now Pat. No. 6,632,501.
(60) Provisional application No. 60/700,074, filed on Jul. 19, 2005.

(51) Int. Cl. C02F 1/28

(52) U.S. Cl. 210/242.4; 442/415; 442/414; 442/121; 442/123; 210/764; 210/505; 210/693

(57) ABSTRACT

Bacterial discharge from a storm water system is substantially eradicated or at least greatly reduced by providing a filter having a filtration and anti-microbial medium, disposed in sump areas of the storm water system. The medium both removes hydrocarbons and kills bacteria in storm water that is retained in sump areas after a storm event. The filter is disposed in the retained water within the system, rather than being positioned merely as a pass-through filter, thereby increasing the contact time between the anti-microbial agent and the bacteria so that large amounts of bacteria are eradicated, and explosive bacterial growth within the sump areas is precluded prior to such bacteria being flushed from the system during the next storm event. The anti-microbial agent is adhered to, combined with, impregnated in, or otherwise joined to the filtration media. Filtration media that includes delustered synthetic fibers is a very efficient absorbent.

### RELATED APPLICATIONS

This application is based on a prior copending provisional application Ser. No. 60/700,074, filed on Jul. 18, 2005, the benefit of the filing date of which is hereby claimed under 35 U.S.C. § 119(e). This application is further a continuation-in-part of a copending patent application Ser. No. 10/646,944, filed on Aug. 21, 2003, which itself is a divisional application of co-pending patent application Ser. No. 09/875,591, filed on Jun. 6, 2001, issued as U.S. Pat. No. 6,632,501 on Oct. 14, 2003, the benefit of the filing dates of which is hereby claimed under 35 U.S.C. § 120.

### TECHNICAL FIELD

The concepts disclosed herein relate generally to the field of filtration of storm water run-off as captured, controlled, and transported by storm water drainage systems. More particularly, these concepts relate to methods and apparatus to filter storm water or surface water run-off to remove hydrocarbons, organic liquids, and particulate matter, as well to eradicate bacteria in the storm water run-off.

### BACKGROUND

As a result of society's high level of use of products containing hydrocarbons or organic liquids, it is not uncommon for such components to be flushed in significant amounts into storm water drainage systems. It is therefore necessary to provide apparatus and methods to remove such contaminants from the storm water prior to discharge of the storm water from the storm water system. In a common conventional approach, a filtration structure capable of capturing the hydrocarbons and organic liquids is disposed at the ingress points of the storm water system, i.e., filter units are positioned in the storm drains such that the contaminants are immediately captured, and storm water passing into the storm water drainage system downstream of the filter units is relatively contaminant-free. In another method, filtration units are positioned at the points of exit of the storm water system, such that contaminants are removed from the storm water prior to its discharge into the environment. For example, an excellent filtration material for this purpose is sold under the trademark X-TEX®, the composition of which is disclosed in commonly assigned U.S. Pat. No. 6,632,501, the drawings and disclosure of which are hereby specifically incorporated herein by reference.

Another problem inherent in storm water discharge is microbial contamination. Bacteria in relatively high concentration may in some circumstances be flushed into the storm water system, but significant microbial contamination of discharge water results from the fact that storm water systems comprise vast networks of storm drains, conduits, collectors and the like, which provide reservoirs of stagnant water that is a breeding ground for microbes.

It should be recognized that all storm water run-off entering a storm water system does not pass fully through the system. As noted above, there are often a large number of areas in a storm drain system where the storm water remains resident in the system for extended periods of time, stagnating. For example, an outlet pipe at the base of a storm drain is typically connected to a catch basin several inches above the bottom of the basin. This configuration results in several inches of water remaining trapped in the bottom or sump of each catch basin after a storm.

Likewise, long runs of connected drainpipes often do not have a continuous down-slope, and consequently, storm water can be trapped in pockets of the conduit system. This trapped water is a prime breeding ground for bacteria, to the point that the bacterial concentration discharging from the storm system after large rains may exceed recognized safe limits.

Providing anti-microbial agents in combination with filtration media at the ingress or discharge points of the storm system does not satisfactorily address this problem, because the time that the bacteria is in contact with the anti-microbial agents positioned at such ingress or discharge points is extremely short, and thus, the effectiveness of the anti-microbial action at such points is very limited, especially for anti-microbial agents disposed at the discharge points of the storm water system, since the discharge water may have extremely high concentrations of bacteria due to the bacterial growth occurring in the sump areas of the storm water system.

It would thus be desirable to provide a method and apparatus for effectively reducing the bacterial concentration in storm water discharge, as well as filtering other contaminants from the water before discharging the water.

### SUMMARY

Bacterial discharge from a storm water system is eliminated or substantially reduced in concentration by providing a combination filtration and anti-microbial apparatus that is disposed in sump areas of the storm water system such that, in addition to removing hydrocarbon and liquid organic contaminants, the concentration of bacteria in storm water that remains resident in the sump areas after a storm event is eradicated or greatly reduced. The combination filtration and anti-microbial medium is disposed in the resident (i.e., retained) water within the system rather than being positioned merely as a pass-through, thereby increasing the contact time between the anti-microbial agents and the bacteria such that large amounts of bacteria are eradicated and explosive bacterial growth within the sump areas is precluded prior to such bacteria being flushed from the system during the next storm event. In various exemplary embodiments, the anti-microbial agent is adhered to, combined with, impregnated in, or otherwise joined to the filtration media, or to some other portion of the apparatus (such as a porous cover encapsulating a bulk filter media). One exemplary type of filtration media comprises a mass of delustered hydrophobic and lipophilic fibers.

Various different exemplary aspects of the concepts disclosed herein are directed to anti-microbial storm water filters, anti-microbial sump filters, methods for reducing microbial contamination of storm water systems, and methods for fabricating anti-microbial filters that are useful in such applications.

Where the anti-microbial agent is associated with the filtration media, it should be recognized that the effective life of the filtration media may be increased by reducing the growth of bacteria, mold, algae, and the like on the filtration media itself.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a block diagram schematically illustrating the basic elements of an exemplary storm water filter with anti-microbial properties, in accord with one aspect of the disclosure provided herein;

FIG. 2A schematically illustrates a test filter with anti-microbial properties utilized for empirical testing;

FIGS. 2B and 2C graphically illustrate empirical test results obtained using the test filter of FIG. 2A;

FIGS. 3A and 3B schematically illustrate an exemplary embodiment of a storm water filter/sump filter with anti-microbial properties, configured for use in water holding reservoirs, such as those found in storm water systems;

FIG. 4 schematically illustrates an exemplary storm water filter with anti-microbial properties configured for use in a storm water ditch, a storm water pipe, or a storm water culvert;

FIG. 5A schematically illustrates an exemplary porous cover configured to hold an amorphous mass of filter media;

FIGS. 5B and 5C schematically illustrate the porous cover of FIG. 5A incorporated into the storm water filter/sump filter with anti-microbial properties illustrated in FIGS. 3A and 3B, to achieve another exemplary embodiment of a storm water filter/sump filter with anti-microbial properties;

FIG. 6A is a schematic view of a filter media comprising a plurality of relatively long hydrophobic and lipophilic fibers intermingled with a plurality of relatively short hydrophobic and lipophilic fibers;

FIG. 6B is an enlarged view of a portion of FIG. 6A;

FIG. 7A is a flowchart illustrating the basic steps for generating a storm water filter with anti-microbial properties according to a first exemplary embodiment;

FIG. 7B is a flowchart illustrating basic steps for generating a storm water filter with anti-microbial properties according to a second exemplary embodiment;

FIG. 8 is a flowchart illustrating exemplary basic steps for treating storm water using a filter with anti-microbial properties; and

FIG. 9 schematically illustrates a filter train including a pre-filter, an optional mid-filter, and a final anti-microbial filter.

### DESCRIPTION

### Figures and Disclosed Embodiments are not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein.

The concepts disclosed herein encompass a method and apparatus for substantially reducing or eliminating hydrocarbon, liquid organic, and bacterial contamination of storm water discharging from a storm water system into the environment. Such method and apparatus can be implemented in any water system that holds or retains water, so that the retained water can become stagnant and act as a breeding ground for undesirable microbes.

Storm water systems are well known and extremely common, typically including large numbers of storm drains and catch basins located in roadway curbs, within large paved areas such as parking lots, in drainage ditches, and the like. The storm drains allow the storm water to flow into catch basins, sumps, or other temporary storage volumes. Conduits are connected to such volumes and transport the storm water to discharge points where the storm water is returned to the environment. A storm water system is often a vast network, and there are numerous components or areas that act as sumps, either intentionally or unintentionally, where storm water is retained and remains resident within the system for extended periods of time, or at least until a subsequent storm event occurs. Such storage volumes/sumps are generally present in the bottom of each catch basin, beneath the storm drains, since the drainpipes are often connected several inches or more above the bottom of the catch basins. In addition, storage volumes/sumps are also often present where long stretches of pipe are not properly installed to achieve the continuous downward slope required to direct storm water in a desired direction, or where shifting of the pipes over time results in a degradation of the slope, creating unintended low spots that do not drain completely.

Because storm water may remain in such storage volumes/sumps for extended periods of time, and because the storage volumes/sumps will not necessarily be completely flushed upon subsequent storm events, the water retained in the storage volumes/sumps is a prime habitat for bacterial growth. As a result, extremely high bacterial concentrations can be evident in the discharge water when flushing of the storm system occurs, for example, during and immediately after a storm event.

The concepts disclosed herein can solve this problem by providing a combination filtration and anti-microbial structure that can be introduced into the storage volumes/sumps of the storm water system (regardless of whether such storage volumes/sumps are intentional or unintentional). The combination filtration and anti-microbial structure thus serves as a resident filter and treatment apparatus. While it is contemplated that the combined filtration and anti-microbial structure can also be employed in a pass-though filter and treatment apparatus, by being positioned, for example, at an outflow pipe, the time during which the bacterial contamination in the water is exposed to the anti-microbial structure will be much less, and the anti-microbial agent may be less effective. Accordingly, somewhat more effective anti-microbial action can be achieved if such a structure is deployed in locations where stagnant water can accumulate even during non-storm conditions, as opposed to locations that are intermittently exposed to water during storm events. Yet, it is not intended that the present concept and approach be in anyway limited only for use in locations where stagnant water accumulates.

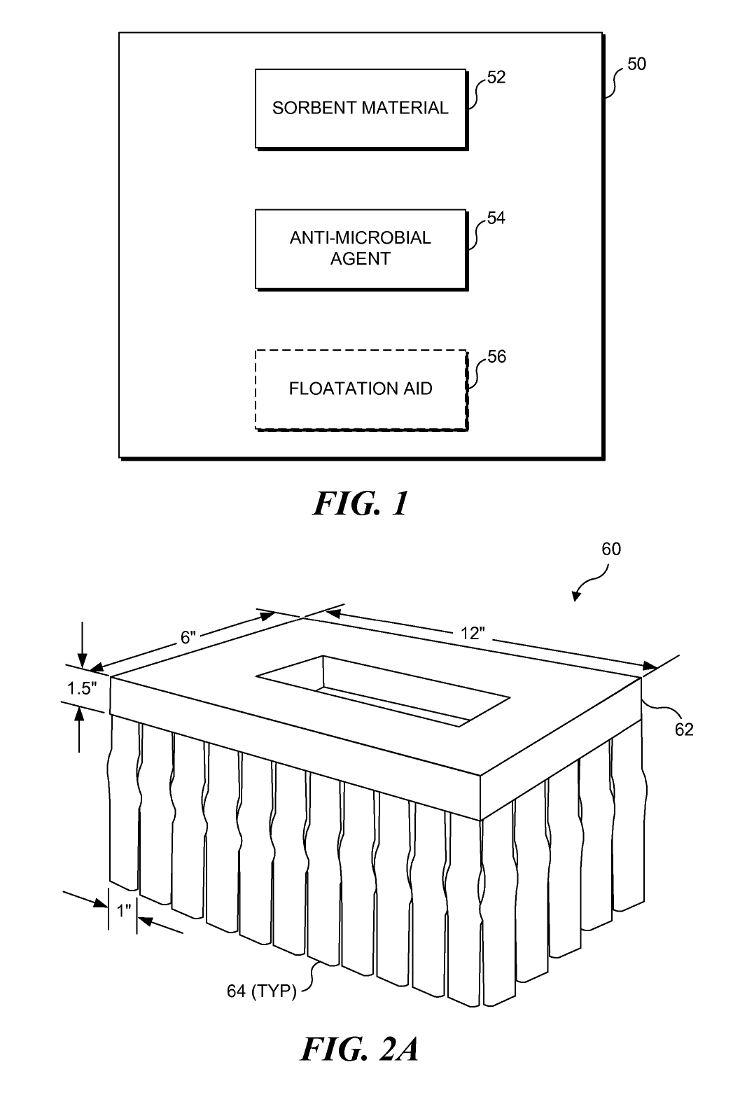

FIG. 1 is a block diagram schematically illustrating the basic elements of an exemplary storm water filter 50 with anti-microbial properties. The basic elements of storm water filter 50 include a sorbent material 52 (i.e., a filtration media) and an anti-microbial agent 54. A flotation aid 56 represents an optional additional element, which facilitates the introduction and positioning of the storm water filter into a sump/storage volume.

It should be recognized that many different types of filter material can be beneficially employed to implement sorbent material 52. A very useful filtration media will adsorb hydrocarbon and liquid organic contaminants, since the presence of these components in storm discharge water is undesirable. Particularly effective filter media include: sorbents based on an amorphous mixture including a majority of synthetic fibers and a minority of natural fibers; sorbents based on amorphous delustered synthetic fibers; sorbents based on non-woven textiles including a majority of synthetic fibers and a minority of natural fibers; and sorbents based on non-woven textiles, including delustered synthetic fibers. Examples of such sorbents are disclosed in commonly assigned U.S. Pat. No. 6,632,501, the disclosure and drawings of which have been specifically incorporated herein by reference. Sorbents of this type are currently marketed under the trademark X-TEX®.

Furthermore, it should also be recognized that many different materials can be used to implement anti-microbial agent 54. The term “anti-microbial” as used herein is intended to include any compound, product, composition, article, etc., that reduces the growth and proliferation of microbial organisms, including but not limited to bacteria, protozoa, molds, fungi, and the like. Such an agent can be suitably bonded, adhered, grafted, impregnated or otherwise joined to a portion of the storm water filter. In some embodiments, particularly where the sorbent is implemented as a non-woven textile, the anti-microbial agent is suitably bonded, adhered, grafted, impregnated or otherwise joined to the sorbent. In other embodiments, particularly where the sorbent is implemented as an amorphous bulk material, for example, encapsulated in a porous cover, the anti-microbial agent is suitably bonded, adhered, grafted, impregnated or otherwise joined to a component of the storm water filter other than the amorphous bulk material (such as the porous cover), so that removal or replacement of the amorphous bulk sorbent material will not affect the anti-microbial properties of the storm water filter. Thus, it should also be recognized that the anti-microbial agent can be incorporated into some other portion of the storm water filter (i.e., some portion other than the sorbent material or a porous cover encapsulating an amorphous bulk sorbent material).

In general, there are two types of anti-microbial technology. A first technology is based on adding a leachable anti-microbial agent to a physical structure (where the leachable anti-microbial agent acts as a poison), while the second technology is based on permanently binding an anti-microbial agent to a physical structure. A possible undesirable characteristic associated with the leachable anti-microbial technology is that at some point, all of the active anti-microbial agent will have migrated away from the physical structure, leaving the physical structure within no anti-microbial properties. In contrast, when the anti-microbial agent is permanently bound to a physical structure, the physical structure continues to exhibit anti-microbial properties until the anti-microbial coating is physically removed. Some types of permanently bound anti-microbial coatings generally include a silane component that acts as the glue to permanently bind to the anti-microbial coating to a surface, and a chemical or other type of agent that kills microorganisms by physical interaction (such as piercing cellular membranes or by applying a lethal electrical potential). With respect to the concepts disclosed herein, the permanently bound anti-microbial coatings can have an advantage over the leachable anti-microbial agents. Many anti-microbial agents that include a silane binding component and a chemical agent are known and are commercially available, and can be beneficially employed to achieve a storm water filter as disclosed herein. An example of one such organosilane anti-microbial agent is described in U.S. Pat. No. 5,954,869. The permanently bound anti-microbial coatings can be readily applied to a surface by spraying the surface with the combination of the silane and the chemical agent, or by dipping a physical object, such as a component of the filter, into a solution comprising the silane and the chemical agent.

During use, the storm water filter is left in a storage volume/sump of the storm water system until its effectiveness becomes diminished, at which time it is replaced. In this manner, storm water within the sump areas is constantly treated such that the concentration of microbes is severely diminished or reduced to zero, prior to the water in the sumps being flushed from the system by the next storm event. In addition, the filter media removes (by adsorption) hydrocarbon and organic liquid contaminants in the sump water. The presence of the anti-microbial agent also prolongs the effective life of the filter media itself, since growth of bacteria, mold or other microbial species on the filter media that may interfere with the effectiveness for filtering other contaminants from the storm water is generally precluded. As noted above, the anti-microbial agent can be permanently bound to a portion of the storm water filter. It is expected that permanently binding the anti-microbial agent to the storm water filter will result in a relatively long service life. However, the anti-microbial surface coating can be physically removed (i.e., by abrasion), and over time, the anti-microbial properties of the storm water filter will likely diminish. Furthermore, where the anti-microbial coating is applied to the sorbent material, saturation of the sorbent material with hydrocarbons may interfere with the anti-microbial coating, requiring cleaning or replacement of the sorbent material. Particularly where the filter is implemented as a fabric (either a woven fabric, a needle punched fabric, or a non-woven fabric), such a filter will also beneficially remove sediments. In general, the use of non-woven fabrics or needle punched fabrics is more cost-effective, as such fabrics are generally less expensive to manufacture.

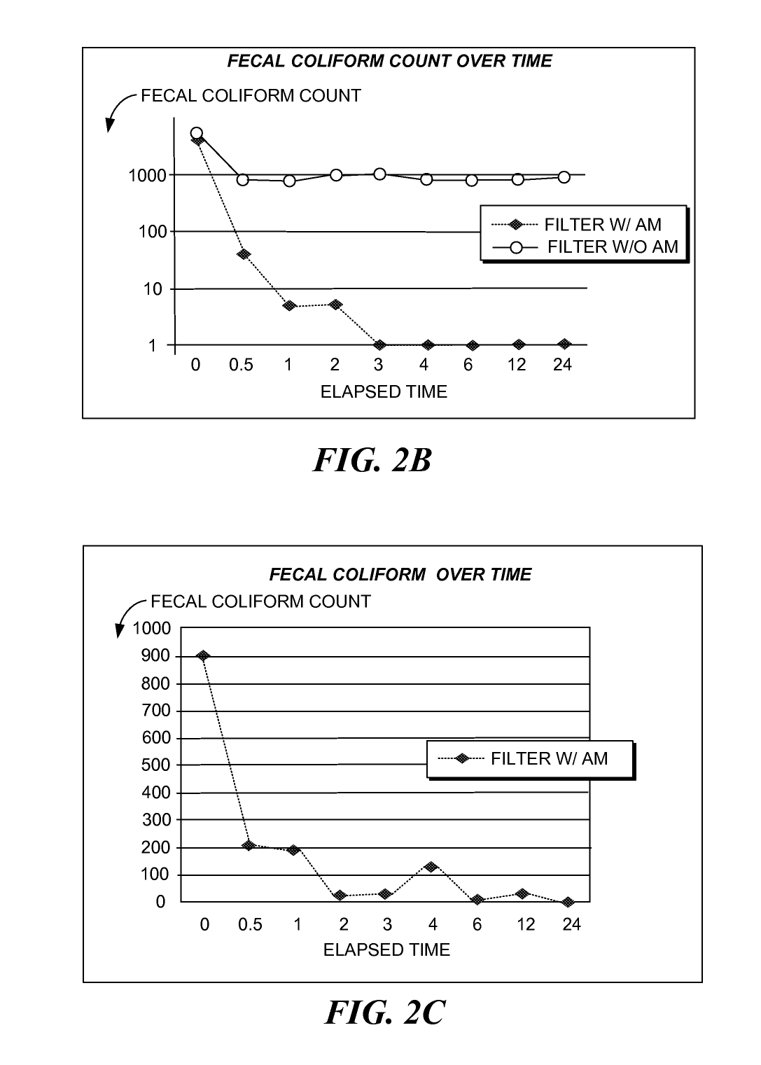

FIG. 2A schematically illustrates a test filter 60 having anti-microbial properties utilized for empirical testing of the concepts disclosed herein. A three-foot by one-foot strip of a non-woven textile treated with a permanently bound anti-microbial coating was hot-glued around the perimeter of a Styrofoam flotation frame 62, with a center cutout used for sampling. The non-woven textile employed (which was the X-TEX material noted above) comprises a majority of delustered synthetic fibers and a minority of natural fibers. The portion of the non-woven textile hanging below flotation frame 62 was cut into one-inch strips 64. This design provides three-dimensional contact with the water, because fabric strips 64 have a density greater than water, and therefore hang down from the flotation frame float. A second test filter apparatus was similarly constructed using a non-woven textile comprising a majority of delustered synthetic fibers and a minority of natural fibers, where the non-woven textile was not treated with the permanently bound anti-microbial coating, to serve as a control for comparison. The specific anti-microbial coating employed was silanequat (i.e., 3-(trimethoxysilyl)propyl-dimethyloctadecyl ammonium chloride), which is a Dow Corning product known as Dow 5700.

FIGS. 2B and 2C graphically illustrate empirical test results obtained using the test filter of FIG. 2A. A fecal coliform bacterium was used as the indicator species in this study. The bacterial seed mixture used was obtained from the clarifier at a local sewer treatment plant. A working standard of 40,000 cfu/100 ml was prepared from the seed mixture by adding 20 ml of the seed inoculum into eight liters of BOD phosphate buffered dilution water at a pH of 7.2, and kept under aeration for 24 hours. The contaminated storm water was produced by adding 8 liters of the working standard to a plastic drum containing 80 liters of buffered distilled water at pH 7.2 and 10 grams of glucose as an organic substrate. This water was then aerated for 24 hours and analyzed for fecal coliform bacteria. The laboratory analysis determined that the simulated storm water contained approximately 4,000 cfu/100 ml of fecal coliform bacteria. Two containers were designed to approximate small urban storm drain basins measuring 18 inches long, 12 inches wide and 12 inches deep. Each container had a lid, which was kept closed except for sampling. The containers were insulated to maintain a constant temperature for the duration of the experiment. The test filter with the anti-microbial coating was placed in one container, while the test filter without the anti-microbial coating was placed in the second container.

The incubation containers were filled with 40 liters (10.6 Gals) of the synthetic contaminated storm water and allowed to equilibrate for 30 minutes. Initial samples were taken in sterile bacteria sample bottles. The anti-microbial flotation apparatus and the control flotation apparatus were positioned in each of the containers, and the timed sampling sequence was begun. Water samples were taken using a 20 ml sterile glass tube. Four samples were taken from each corner of the container and two from the center; these samples were combined into sterile bacteria bottles for each timed sample event submitted for testing. The timed sequence of sampling progressed from minutes to hours. The samples were maintained at 4° C., and submitted for analysis within 24 hours of sampling. The samples were analyzed by Method SM9222D for Fecal Coliform MF; the results are summarized in FIG. 2B, which clearly illustrates that the test filter without the anti-microbial coating provides only a minimal initial reduction in fecal coliform counts, whereas the test filter including the anti-microbial coating provides a significant reduction in fecal coliform counts, such that over an extended period, the fecal coliform population is almost entirely eliminated by the filter with the anti-microbial coating. Because the non-woven textile employed (with and without the anti-microbial treatment) exhibits a vast network of interstitial spaces, it is believed that the initial reduction in fecal coliform counts exhibited by the non-woven textile without the anti-microbial treatment is due to the fecal coliform becoming trapped in the interstitial spaces, and thus being unrecoverable during sampling.

To verify that the covalently bonded anti-microbial treatment (i.e., the permanently bound anti-microbial coating) will retain its efficacy and not leach off the filtration fabric after repeated washing and drying cycles, the following test was performed. The non-woven textile treated with the silanequat anti-microbial coating was washed 10 times with warm water and rung dry between washings. The treated non-woven fabric was allowed to hang dry overnight. This washing cycle was done to ensure that any silanequat not covalently bonded to the fabric's fiber would be washed off along with any other component within the fabric that could be chemically detrimental to the fecal coliform. The washed fabric was attached to the flotation apparatus and placed within the incubation container. The conditions of the first procedure described above were duplicated, and the results are summarized in FIG. 2C, which again clearly illustrates that the test filter including the anti-microbial coating provides a significant reduction in fecal coliform counts.

The test filter with the anti-microbial coating, as compared to the control filter without the anti-microbial coating, removed 95 percent of the population of fecal coliforms in the first 30 minutes of contact, and 100 percent within a three hour period in the control study. The efficacy of the washed fabric removed over 76 percent of the fecal coliforms within the first 30 minutes of contact, and 96.6 percent within three hours. Both stagnant water tests using the treated fabric and the washed fabric maintained 100 percent removal after 24 hours. It should be noted that this study was only monitoring the efficacy for fecal coliform bacteria. Other gram (+) and gram (−) bacteria, mycelial fungi, yeasts, and algae were also being killed in the simulated storm water. Both the anti-microbial treated test filter and the untreated test filter (i.e., the control) experienced a severe drop from the initial bacteria levels. This initial drop may be due to bacterial uptake into the fiber matrix, shock to the bacteria being transferred into a new environment, or some component leaching off the unwashed fabric that was detrimental to the bacteria. The fecal coliform population stabilized to 800-1000 cfu/100 ml in the untreated control, but dropped to non-detectable levels with the treated fabric. The washed fabric illustrated similar efficiency; however the initial fecal coliform count was 900 at the start of the test. This may be due to the longer stabilization time allowed before taking the initial sample.

Unlike a chemical pollutant, bacterial contamination is dynamic and grows exponentially from one bacterium into billions within 24 hours under optimal conditions. Bacteria will also adapt and mutate to develop resistant strains when water-soluble antimicrobial agents or disinfectants are used. This mutation occurs because the water-soluble anti-microbial agents become diluted out to sub-lethal levels, allowing adapting resistant forms to persist and endangering storm water from becoming infected with resistant bacterial populations. The test filter with the permanent anti-microbial coating tested in the study discussed above was designed to overcome these problems by using an immobilized surface-bonded silanequat that kills bacteria by molecular penetration and electrical action. Since the anti-microbial is covalently bonded to the non-woven fabric, it will not dilute to sub-lethal levels and the physical kill mechanism will not be consumed by repeated contact with bacteria. The non-woven textile comprising a majority of the delustered synthetic fibers and a minority of natural fibers represents a particularly effective material, which exhibits excellent oil absorption properties and vast interstitial spaces. The fabric's open design allows the free flow of water in every direction and has great wicking ability. When coupled with a surface immobilized anti-microbial agent, the resulting fabric becomes a powerful delivery system for bacterial removal in storm water systems. The fabric can be cut, formed or molded for use in any new or existing Best Management Practice (BMP) storm water system or design. Beneficial areas of applications would include cisterns, pipes, drain basins, culverts, cooling towers and any other stagnant water areas contaminated with bacteria or oil. Note that binding the anti-microbial to the filter media increases the effective life of the filtration media by reducing the growth of bacteria, mold, algae and the like on the filtration media itself.

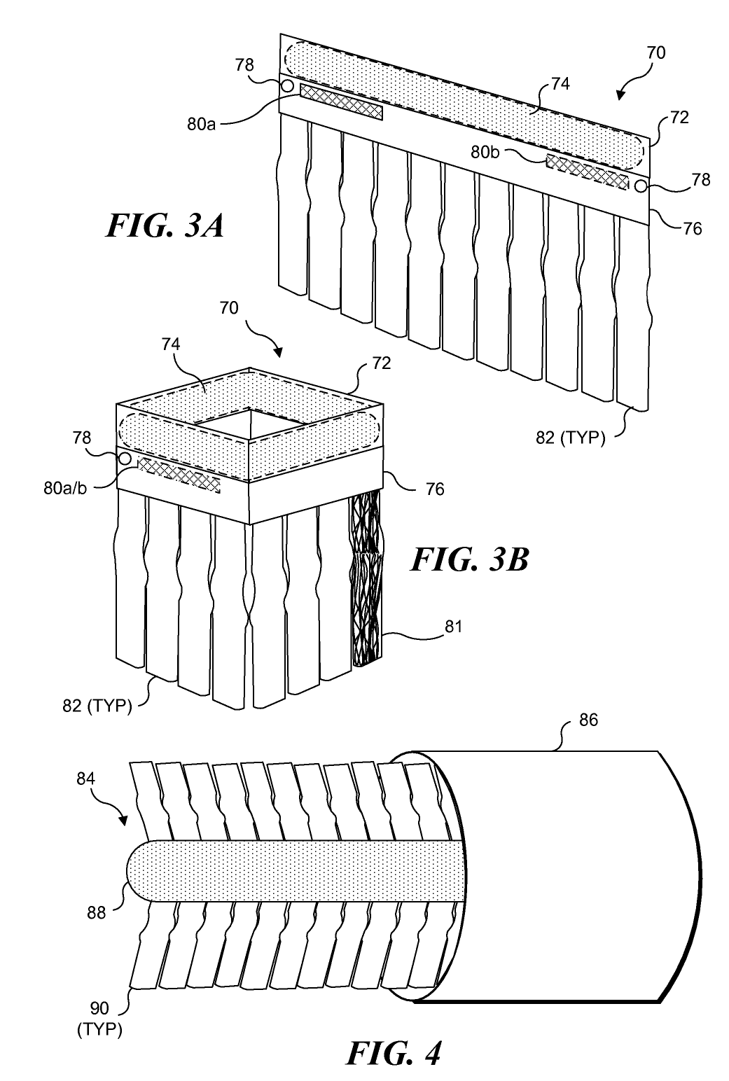

FIGS. 3A and 3B schematically illustrate an exemplary embodiment of a storm water filter/sump filter 70 that has anti-microbial properties and is configured for use in a water holding reservoir (e.g., a storage volume/sump), such as those found in storm water systems, or for use in almost any type of water drain system where water is retained and may become stagnate. Filter 70 includes an upper panel 72 encapsulating a flotation aid 74 (such as a flexible open cell foam), a mid-panel 76 including hook and loop fasteners 80a and 80b (note that fastener 80b is shown using phantom lines to indicate that fastener 80b is disposed on a backside of mid-panel 76, while fastener 80a is disposed on a front side of mid-panel 76) and openings 78 (to facilitate coupling a plurality of filters together for use in larger sumps), and a plurality of downwardly extending non-woven fabric tendrils 82. Those of ordinary skill in the art will readily recognize the many similarities shared between sump filter 70 and test filter 60 (such as the anti-microbial coating, the flotation aid, and the downwardly depending tendrils). In this exemplary embodiment, sump filter 70 is sufficiently flexible so that it can be folded (as illustrated in FIG. 3B) and readily inserted into a generally cubicle volume (although it should be recognized that such flexibility will also enable the sump filter to be inserted into volumes having a wide variety of different sizes and shapes). The length of tendrils 82 can be modified to accommodate volumes having smaller or larger depths. It is expected that upper panel 72 and mid-panel 76 will be fabricated from high-quality and rugged synthetic fabric, to ensure a relatively long service life.

Tendrils 82 can be fabricated from the non-woven textile fabric employed in test filter 60 (i.e., a non-woven textile comprising a majority of delustered synthetic fibers and a minority of natural fibers that exhibits oil absorbent properties, vast interstitial spaces, and allows free flow of water through the fabric), which has been coated with an anti-microbial agent permanently bonded to the fabric. It should be recognized that the fabric can be treated with the anti-microbial agent after the fabric has been manufactured (such that the anti-microbial agent is bonded to the surface of the fabric), or alternatively, the fibers can be treated with the anti-microbial agent before the fibers are formed into the fabric, such that the anti-microbial agent is bonded to the fibers, and therefore distributed throughout the vast interstitial spaces defined by the fibers. In at least one embodiment, however, one (or more, or all) of the tendrils are configured as a porous cover 81 (see FIG. 3B) employed to encapsulate an amorphous bulk filter media. For example, rather than forming the majority of delustered synthetic fibers and minority of natural fibers into a non-woven textile, the bulk fibers can be introduced into the porous cover as an amorphous mass. A benefit of such a design is that the amorphous bulk fiber material can be replaced when it is spent (i.e., saturated with oil or other hydrocarbons). The amorphous bulk fiber material can be treated with the anti-microbial agent, or the porous cover can be treated with the anti-microbial agent, such that removal or replacement of the amorphous bulk fiber material does not affect the anti-microbial properties of the sump filter.

FIG. 4 schematically illustrates an exemplary storm water filter 84 with anti-microbial properties configured for use in a storm water ditch, a storm water pipe, or a storm water culvert (as generally indicated by reference numeral 86). Storm water filter 84 includes a generally elongate central support structure 88 (which in at least one embodiment is implemented using a high-quality rugged synthetic fabric), and a plurality of outwardly extending tendrils 90. As discussed above, tendrils 90 can be implemented using the oil absorbent non-woven textile fabric treated with the anti-microbial agent, as discussed in detail above. However, tendrils 90 can also be implemented as a porous cover configured to accommodate a mass of an amorphous bulk filter media, generally as also described above. Central support 88 can be configured to include a flotation aid, if desired. In at least one embodiment, central support 88 is sufficiently rigid to enable filter 84 to be forced into a pipe, much as a pipe cleaner would be inserted into a tobacco pipe. In other embodiments, central support 88 is sufficiently flexible to enable filter 84 to be inserted into curvilinear volumes, or deformed sufficiently for insertion into a water retention volume through an opening.

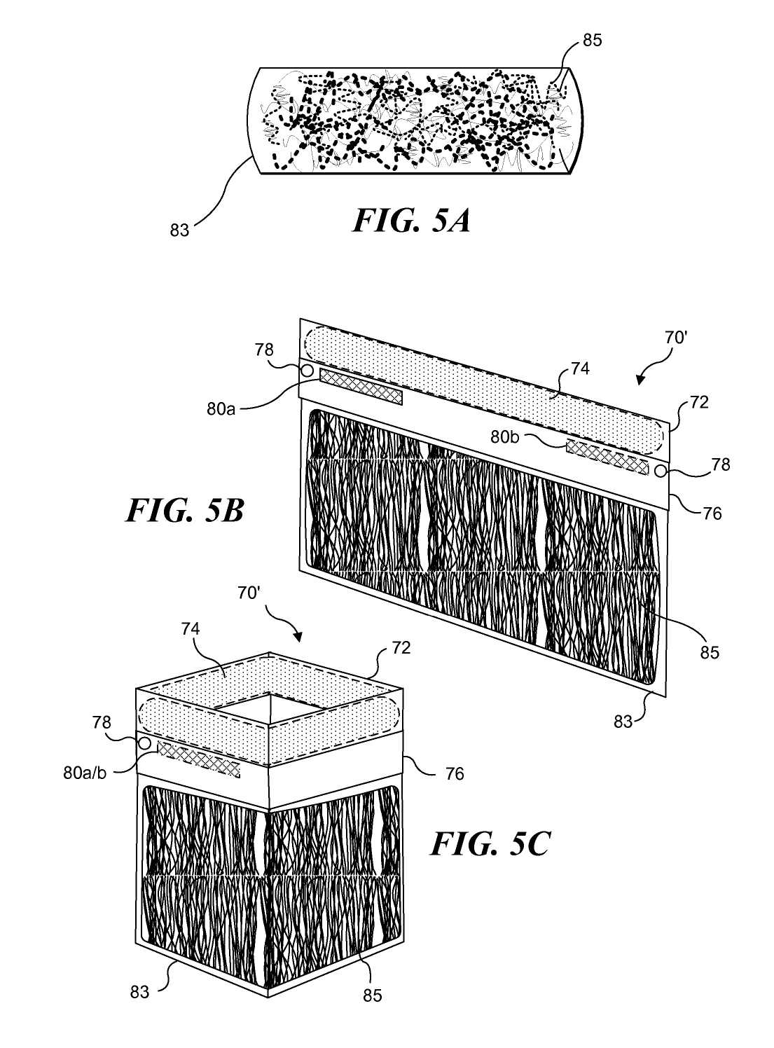

FIG. 5A schematically illustrates an exemplary porous cover 83 configured to hold an amorphous mass of filter media 85, such as a mass of individual fibers comprising a majority of delustered synthetic fibers and a minority of natural fibers, as discussed above. FIGS. 5B and 5C schematically illustrate the porous cover of FIG. 5A incorporated into the storm water filter/sump filter with anti-microbial properties, that is illustrated in FIGS. 3A and 3B, to achieve another exemplary embodiment of a storm water filter/sump filter 70′ with anti-microbial properties (where the tendrils of sump filter 70 (FIGS. 3A and 3B) have been replaced by porous cover 83 encapsulating amorphous mass filter media 85). Other components of storm water filter/sump filter 70′ are similar to those of sump filter 70 and are identified with corresponding reference numerals. As noted above, the anti-microbial agent can be applied to the amorphous bulk filter media, or to the porous cover (or both).

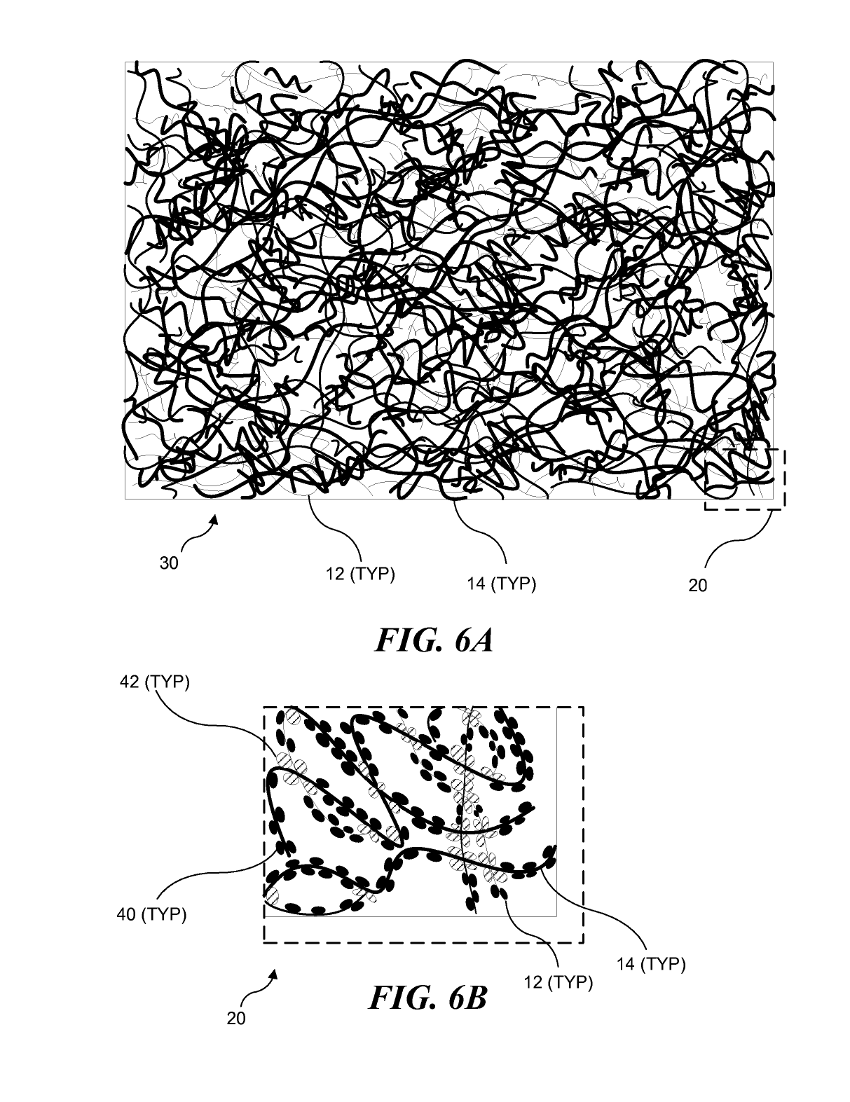

FIGS. 6A and 6B provide details relating to the efficient sorbent material utilized in the test filter of FIGS. 2A-2C (details of this type of sorbent material are described in commonly assigned U.S. Pat. No. 6,632,501, the drawings and specification of which have been specifically incorporated herein by reference). Such a filter media is characterized by its oil absorbance, the provision of vast interstitial spaces, and by its ability to allow a free flow of water through the material. This type of filter media is available as an amorphous bulk material and as a non-woven textile or fabric. The exact proportions of the individual fibers are not critical, although a majority of the fibers should be synthetic, and only a minority of the fibers should be natural. The majority of synthetic fibers are hydrophobic and lipophilic (i.e., capable of adsorbing hydrocarbon products). Synthetic fibers such as polyester, nylon, acrylic, and triacetate can be beneficially employed for the majority of fibers. In one exemplary embodiment, approximately 70% of the fibers are polyester, approximately 20% of the fibers are nylon, less than about 2% of the fibers are acrylic, and less than about 1% of the fibers are triacetate; however, the relative percentages of these fibers can vary considerably and still provide a useful sorbent, since each of the fibers individually meet the criteria of being hydrophobic and lipophilic (capable of sorbing a hydrocarbon).

It has been determined that delustering enhances the sorbency of synthetic fibers, which inherently have a sheen due to their smooth outer surface. The delustering effect has been empirically determined, and it is believed that at least two mechanisms are responsible for the increase in the sorbency of delustered fibers. First, delustering significantly roughens the surface of individual fibers, substantially increasing the surface area of each fiber, and thus enabling a greater amount of adsorption per fiber. Second, it should be noted that rough surfaces of the individual fibers, in combination with the mix of short and long fiber lengths, enable a surprisingly cohesive wad of fiber sorbent to be achieved. The rough surfaces provide fiber-to-fiber traction, enabling adjacent fibers to better adhere to one another. The mix of a minor portion of relatively long fibers to a majority of relatively short fibers ensures that sufficient relatively long fibers are present to help bind the wadded mass together without the need for binding agents normally employed to bind amorphous masses of fiber together. This wadded mass configuration ensures that a significant amount of interstitial volume is available for absorption of contaminants. Thus, delustering is believed to enhance sorption by providing more sites for both adsorption and absorption to occur. Although the wadded mass of fibers, with its majority of relatively short fibers providing significant surface area, begins to sorb hydrocarbon products immediately upon contact, it may be desirable to leave the wadded mass in contact with the hydrocarbon product to be sorbed for at least sufficient time (for example, 10 minutes or more) to enable most of the contaminants to be absorbed. While the process of adsorbing hydrocarbon products onto surfaces of the relatively short fibers, and the surfaces of relatively long fibers occurs rapidly, the process of absorption is expected to require more time to reduce contaminant concentration in the water being filtered, to acceptable levels. Absorption will occur in interstitial regions within the wadded mass. Delustering using titanium dioxide is one effective technique, since it adds a significant amount of surface area to each individual fiber surface, as well as helping the fibers maintain a wadded mass configuration in which a plurality of interstitial volumes are available for absorption. Accordingly, it is believed that leaving the sorbent wadded mass of the present invention in contact with hydrocarbon products to be sorbed for additional time will enable hydrocarbon products to be more fully absorbed into these interstitial volumes within the wadded mass of delustered fibers.

If virgin synthetic fibers are to be used to produce a sorbent for use in an anti-microbial filter in accord with the concepts disclosed herein, such virgin synthetic fibers can be delustered to enhance their oil absorbency properties. If recycled synthetic textile products are shredded to generate a fiber sorbent, further delustering is not likely to be required, because the majority of synthetic fibers used in the textile industry are delustered to enhance their value in textiles. It should be noted that while a mixture of a majority of delustered synthetic fibers and a minority of natural fibers provides better absorbency, a particularly useful filter media can also be produced using only synthetic fibers. A filter media comprising only (or a majority of) natural fibers is less desirable, because such natural fibers do not have the affinity for oil and other hydrocarbons that synthetic fibers exhibit.

A wadded mass/non-woven textile 30 comprising a majority of delustered synthetic fibers and a minority of natural fibers is schematically illustrated in FIG. 6A. A plurality of generally delustered synthetic fibers 12 are intermingled with a relatively small amount of natural fibers 14. The natural fibers are not strictly required (i.e., a beneficial filter media can be achieved using entirely synthetic fibers), but when recycled fibers are being employed, it is difficult to obtain a large volume of synthetic fibers that does not also include a minor portion of natural fibers. A mixture of a minority of relatively long fibers and a majority of relatively short fibers can enhance the sorbent because the minority of relatively long fibers bind the mass of interleaved fibers (both long and short) together into a desirable cohesive wadded mass. Furthermore, the majority of relatively short fibers considerably increase the surface area associated with the wadded mass/non-woven textile. Empirical testing has confirmed that a high surface area is key to a sorbent that begins sorbing material very rapidly, as well as being an important factor in achieving a sorbent that has a high capacity to absorb hydrocarbons.

FIG. 6B, which illustrates an enlarged view of a portion 20 of FIG. 6A, shows how wadded mass/non-woven textile 30 provides a sorbent that exhibits both adsorbent capabilities, as well as absorbent capabilities. Hydrocarbon products 40 are adsorbed on individual surfaces of both synthetic fibers 12 and natural fibers 14 (although, primarily on the synthetic fibers). Hydrocarbon products 42 are absorbed into the interstitial spaces within wadded mass/non-woven textile 30, proximate to locations where the interleaved fibers cross each other.

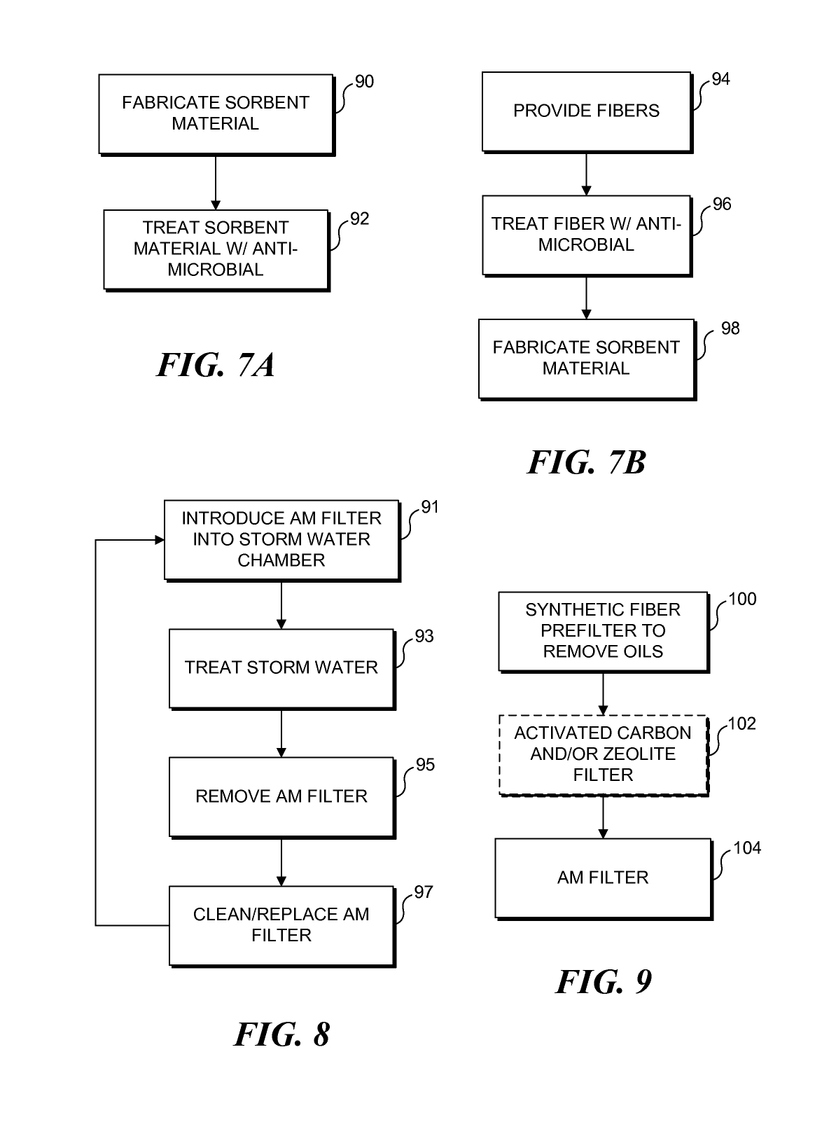

FIG. 7A is a flowchart illustrating the basic steps for generating a storm water filter with anti-microbial properties according to a first exemplary embodiment. In a block 90, a sorbent material (preferably, having oil absorbent capability) is fabricated; while, in a block 92, the sorbent material is treated with an anti-microbial agent (preferably an agent that permanently binds to the sorbent material). As discussed in detail above, the sorbent material can be an amorphous bulk material (i.e., a fiber mass) or a non-woven fabric/textile.

FIG. 7B is a flowchart illustrating the basic steps for generating a storm water filter with anti-microbial properties, according to a second exemplary embodiment. In this embodiment, fibers (preferably synthetic) are provided in a block 94 and are then treated with an anti-microbial agent in a block 96. The step of providing the fibers can include, for example, the steps of procuring virgin synthetic fibers, which are then delustered, or employing recycled synthetic fibers (already usually delustered); and the fibers can include natural fibers as well as synthetic. The resulting fiber material is used to fabricate the sorbent material in a block 98. Fabricating the sorbent material can comprise fabricating an amorphous bulk material (preferably comprising a majority of delustered synthetic fibers and a minority of natural fibers) or a non-woven textile (preferably comprising a majority of delustered synthetic fibers and a minority of natural fibers).

FIG. 8 is a flowchart illustrating the basic steps for treating storm water using a filter with anti-microbial properties. In a block 91, anti-microbial filter(s), such as those described above, are introduced into a storm water chamber or basin. It is contemplated that the storm water chamber represents a volume in which stagnant water can accumulate, or where water can be held for a period of time (as opposed to a volume or region in which water is present only infrequently (for example, during a storm event, or through which water simply flows). In a block 93, the filter(s) treat(s) the storm water to reduce or substantially eliminate microbial contamination. The exemplary filters described above also remove oil and other hydrocarbons contaminating the water, which will likely also be desired. In a block 95, the filter(s) is/are removed whenever the anti-microbial has worn off (generally due to abrasion) or the filter(s) has/have become saturated with oil, reducing the effectiveness for removing additional contaminants. In a block 97, the existing filter(s) is/are cleaned or new filter(s) installed, and the process is repeated by placing the cleaned or new filter(s) into the storm water chamber once again.

While the concepts disclosed above have been described as a combination of the filter media and anti-microbial media, it is also possible to accomplish the anti-microbial treatment of sump areas utilizing a fabric or other matrix to carry the anti-microbial agent, where the matrix does not exhibit filtration properties. Thus, an additional aspect of the concepts disclosed herein encompasses an anti-microbial sump insert comprising a support structure/matrix and an anti-microbial coating. For example, the oil absorbent fabric tendrils of FIGS. 3A, 3B, and 4 can be replaced by a fabric that does not absorb much, if any, oil, or even a non-fabric structures such as a wire or polymer screens, which serve as a support for the anti-microbial agent. Referring to FIGS. 5B and 5C, the anti-microbial agent can be bound to the porous cover, which does not need to be filled with an amorphous bulk filter media, if filtration or oil absorbance is not desired.

FIG. 9 schematically illustrates a filter train including a pre-filter 100, an optional mid-filter 102, and a final anti-microbial filter 104. As noted above, empirical testing has indicated that the exemplary synthetic fiber based anti-microbial filter described in detail above, exhibits reduced effectiveness when it becomes saturated with oil or other hydrocarbons. The anti-microbial treatment increases the cost of the synthetic fiber based anti-microbial filter as compared to a synthetic fiber based filter without the anti-microbial coating. By using a less expensive pre-filter, the service life of the anti-microbial filter can be significantly enhanced. Furthermore, it should be noted that the pre-filter and the anti-microbial filter do not need to be positioned immediately adjacent to one another to gain the benefits of extending the life of the anti-microbial filter, as long as the pre-filter is placed upstream of the anti-microbial filter. Consider a hypothetical water system that includes three water conduits that are relatively easy to access, each of which lead to a common sump or reservoir, which is relatively difficult to access. Pre-filters can be installed in each conduit, and a single anti-microbial filter can be installed in the common sump. The pre-filters can be relatively easily replaced or cleaned whenever they become saturated with hydrocarbons. By preventing the hydrocarbons from reaching the anti-microbial filter, the lifespan of the anti-microbial filter is significantly enhanced. Not only does this reduce replacement costs attributable to the cost of the anti-microbial filter itself, it also reduces manpower expenses associated with frequently accessing the relatively inaccessible common sump. That is, overall costs are reduced by reducing the frequency with which the anti-microbial filter in the hard to access common sump must be replaced. It should be recognized that while only one pre-filter is shown in FIG. 9, that multiple pre-filters can be employed, particularly when there are multiple conduits feeding a single sump or reservoir. While the synthetic fiber based filter material described in detail above represents a particularly preferred pre-filter, it should be recognized and other types of pre-filters configured to remove hydrocarbons can also be beneficially employed.

Mid-filter 102 is optional (i.e., it is not required to obtain the benefits of enhancing the service life of the anti-microbial filter), but may be included to provide additional benefits. For example, mid-filter 102 can include activated carbon to remove hydrocarbons or other contaminants that are not removed by the pre-filter. It is likely that the service life of mid-filter 102 will also be enhanced by the pre-filter, such that mid-filter 102 may not need to be replaced as often as the pre-filter. This enables mid-filter 102 to include relatively more expensive filtration media configured to address specific filtration needs. For example, mid-filter 102 can also incorporate zeolites, a class of filter media that can be used to selectively remove contaminants such as heavy metals. It should be recognized that activated carbon and zeolites can be used individually or in combination in mid-filter 102. Furthermore, it should be recognized that other filtration media can be beneficially incorporated into one or more mid filters 102 to address specific filtration needs (thus it should be recognized that the filter train may include more than the three specific filters shown in FIG. 9; those three filters representing exemplary filter types that can be beneficially incorporated into a filter train). Furthermore, it should be recognized that use of such a filter train is not limited to storm water systems alone, and can be implemented in any water system that would benefit from anti-microbial treatment over an extended period of time (i.e., by using a pre-filter to enhance the service life of the anti-microbial filter).

It should be recognized that the discussion above employs both the terms absorb (and absorbent) and adsorb (and adsorbent). In general, the term adsorb is associated with a physical process whereby a fluid (generally a liquid) is attracted to the physical surface of a material. Similarly, the term absorb is generally associated with a physical process whereby a fluid (generally a liquid) is trapped in a volume defined in a material (like the pores in a sponge). Particularly with respect to the exemplary delustered synthetic fiber based sorbent material described in detail above, both the terms adsorb and absorb apply to the exemplary material. In amorphous bulk form and in fabric form, the exemplary delustered synthetic fiber based material exhibits a large volume of interstitial spaces into which a liquid can be absorbed. Furthermore, the delustered synthetic fibers themselves have a very large surface area onto which a liquid can be adsorbed. Thus, a delustered synthetic fiber based filter material is both an adsorbent and an absorbent.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A storm water filter exhibiting anti-microbial properties, comprising:
(a) a filter media configured to absorb oil and hydrocarbons;
(b) a support for the filter media; and
(c) an anti-microbial agent permanently bound to a portion of the storm water filter, such that the anti-microbial agent is substantially non-leachable in storm water.

2. The storm water filter of claim 1, wherein the filter media comprises a bulk amorphous material, and the support comprises a porous cover configured to encapsulate the bulk amorphous filter media.

3. The storm water filter of claim 2, wherein the anti-microbial agent is coupled with the porous cover.

4. The storm water filter of claim 1, wherein the filter media comprises a plurality of delustered synthetic fibers.

5. The storm water filter of claim 1, wherein the filter media comprises a majority of delustered synthetic fibers and a minority of natural fibers.

6. The storm water filter of claim 1, further comprising a flotation member coupled to the support and configured to enable the storm water filter to float on a liquid surface.

7. The storm water filter of claim 1, wherein the filter media comprises a non-woven fabric comprising delustered synthetic fibers.

8. The storm water filter of claim 7, wherein the non-woven fabric is configured as a plurality of elongate tendrils having a density greater than water, such that when the storm water filter is suspended in water, the plurality of elongate tendrils extend downwardly into the water.

9. The storm water filter of claim 1, wherein the anti-microbial agent comprises a silane-based binding agent, and a chemical agent exhibiting anti-microbial properties.

10. A sump filter exhibiting anti-microbial properties, comprising a support structure configured to be inserted into a volume of water, at least a portion of the sump filter being coated with an anti-microbial agent, the anti-microbial agent being permanently bound to the portion, such that the anti-microbial agent is substantially non-leachable in water.

11. The sump filter of claim 10, further comprising a floatation aid.

12. The sump filter of claim 10, further comprising a filter media comprising delustered synthetic fibers.

13. The sump filter of claim 12, wherein the filter media comprises a bulk amorphous material retained within the support structure.

14. The sump filter of claim 13, wherein the portion coated with the anti-microbial agent corresponds to a porous cover configured to encapsulate the bulk amorphous material, such that removal and replacement of the bulk amorphous filter media does not diminish the anti-microbial properties of the sump filter.

15. The sump filter of claim 12, wherein the filter media comprises a non-woven textile.

16. The sump filter of claim 15, wherein the non-woven textile is denser than water, and the non-woven textile is configured to sink and thereby extend downwardly into a sump volume when the sump filter is deployed.

17. The sump filter of claim 15, wherein the portion coated with the anti-microbial agent corresponds to the non-woven textile.

18. The sump filter of claim 10, wherein the anti-microbial agent comprises a silane-based binding agent, and a chemical agent exhibiting anti-microbial properties.

19. A method for reducing microbial contamination in a storm water system, comprising the steps of:
(a) introducing an anti-microbial filter into a volume in which water is likely to be retained, even after a storm event has passed; and
(b) treating the water in the volume, such that the anti-microbial filter substantially reduces a number of microbes in the water while the water is disposed within the volume.

20. The method of claim 19, wherein the step of introducing the anti-microbial filter into the volume comprises the step of inserting the anti-microbial filter into the volume such that at least a portion of the anti-microbial filter extends downwardly into the volume.

21. The method of claim 19, wherein the step of introducing the anti-microbial filter into the volume comprises the step of employing an anti-microbial filter that also exhibits hydrocarbon contaminant absorption properties.

22. The method of claim 21, wherein if the anti-microbial filter is saturated with hydrocarbon contamination, further comprising the step of either:
(a) replacing the anti-microbial filter with an anti-microbial filter that is not saturated with hydrocarbon contamination; or
(b) removing the anti-microbial filter, substantially cleaning the hydrocarbon contamination from the anti-microbial filter, and reinstalling the anti-microbial filter that has been cleaned.

23. A method for fabricating an anti-microbial sump filter, comprising the steps of:
(a) providing a sorbent material;
(b) incorporating the sorbent material into a supporting structure for the anti-microbial sump filter; and
(c) treating a portion of the anti-microbial sump filter with an anti-microbial agent, such that the anti-microbial agent does not substantially leach from the anti-microbial sump filter when the anti-microbial sump filter is placed in water.

24. The method of claim 23, further comprising the step of attaching a flotation aid to the anti-microbial sump filter.

25. The method of claim 23, wherein the step of providing a sorbent material comprises the step of reducing textile materials to a fibrous state to generate a mass of fibers comprising a majority of delustered synthetic fibers.

26. The method of claim 23, wherein the step of providing a sorbent material comprises the step of providing a non-woven fabric comprising a majority of delustered synthetic fibers.

27. The method of claim 23, wherein the step of incorporating the sorbent material into the supporting structure comprises the step of supporting the sorbent material with the supporting structure so that the sorbent material extends downwardly into a volume of water when the anti-microbial sump filter is deployed in the volume of water.

28. The method of claim 23, wherein the step of treating a portion of the anti-microbial sump filter with the anti-microbial agent comprises the step of utilizing a silane-based binding agent and a chemical agent exhibiting anti-microbial properties as the anti-microbial agent.

29. The method of claim 23, wherein the step of treating the portion of the anti-microbial sump filter with the anti-microbial agent comprises the step of treating the sorbent material with the anti-microbial agent.

30. The method of claim 23, wherein the step of treating the portion of the anti-microbial sump filter with the anti-microbial comprises the step of treating a porous cover configured to encapsulate the sorbent material with the anti-microbial agent, such that replacement of the sorbent material does not diminish the anti-microbial properties of the anti-microbial sump filter.

31. A method for fabricating an anti-microbial sump filter, comprising the steps of:
(a) fabricating a mass of delustered synthetic fibers;
(b) treating the mass of delustered synthetic fibers with an anti-microbial agent, such that the anti-microbial agent generally does not leach from the mass of delustered synthetic fibers when the mass of delustered synthetic fibers is exposed to water; and
(c) retaining the mass of delustered synthetic fibers material within the anti-microbial sump filter.

32. A treatment train for water filtration, comprising:
(a) a pre-filter configured to remove hydrocarbons from a volume of water; and
(b) an anti-microbial filter configured to reduce an amount of microorganisms in the volume of water.

33. The treatment train of claim 32, wherein the anti-microbial filter comprises an anti-microbial agent permanently bound to a portion of the anti-microbial filter, such that the anti-microbial agent is substantially non-leachable in water.

34. The treatment train of claim 32, wherein the anti-microbial filter comprises delustered synthetic fibers.

35. The treatment train of claim 32, wherein the pre-filter comprises delustered synthetic fibers.

36. The treatment train of claim 32, further comprising a mid-filter, the mid-filter comprising at least one of:
(a) an activated carbon based filter media;
(b) a zeolite based filter media; and
(c) a filter media configured to treat a contaminant other than a hydrocarbon or a microorganism.
